(19) United States
(12) Patent Application Publication
(10) Pub. No.: US 2015/0008617 A1
(43) Pub. Date: Jan. 8, 2015

(54) METHOD AND DEVICE FOR PRODUCING A THREE-DIMENSIONAL PREFORM FROM A FIBRE FABRIC AS PART OF PRODUCTION OF FIBRE-REINFORCED FORMED COMPONENTS

(71) Applicant: Dieffenbacher GmbH Maschinen-und Anlagenbau, Eppingen (DE)

(72) Inventors: Matthias Graf, Bretten (DE); Tobias Fuerst, Karlsruhe (DE); Steffen Maertiens, Bruchsal (DE)

(21) Appl. No.: 14/372,372

(22) PCT Filed: Jan. 18, 2013
(86) PCT No.: PCT/EP2013/050912

§ 371 Date: Jul. 15, 2014

(30) Foreign Application Priority Data
Jan. 18, 2012 (DE) 102012200699.0

(51) Int. Cl. B29C 31/04; B29C 33/02

(52) U.S. Cl. CPC B29C 31/04; B29C 33/02
USPC 264/291; 425/352

(57) ABSTRACT

The invention relates to a method and a device for producing a three-dimensional preform (19) from a fibre fabric (1) as part of production of fibre-reinforced formed components, comprising a draping device (3) and a transport device (21) for the fibre fabric (1), wherein said draping device (3) at least comprises a draping form (18) for a fibre fabric (3) and means, movable in relation to the draping form (18), for reshaping the fibre fabric (3) on the basis of the contour of the draping form (18). The problem addressed by the invention is that of ensuring swift yet high-quality reshaping, particularly of large-area and/or complex geometries of a preform. To solve the method problem, the invention states that the transport device (21) successively releases the fibre fabric (1) in the direction of the draping form (18) and the released regions of the fibre fabric (1) are fixed and/or draped on the draping form by means of a fixing stamp (4) and/or a draping stamp (5).

The invention relates to a method for producing a three-dimensional preform from a laid scrim in the course of production of fibre-reinforced moulded parts according to the preamble of claim 1 and a device for producing a three-dimensional preform from a laid scrim as part of production of fibre-reinforced moulded parts according to the preamble of claim 8.

In the course of producing fibre-reinforced plastic components, which are also known as fibre composite parts, the RTM process (resin-transfer-moulding process) is used in practice, especially in the industry. The entire production process up to a useful plastic component consists of several, successively performed individual processes. Preforms/semi-finished fibre products which are close to the final shape are produced in a first method step. In this preform process, several layers of fabric or laid scrims (usually provided in two-dimensional form) are usually stacked and optionally joined (sewing, welding, gluing), so that the fibre fabric stack already substantially has the necessary outer contours and partly also comprises special layers or layer thicknesses. A binder is preferably introduced into the separating planes of the laid scrims, which upon reaching a formed three-dimensional shape and its activation and curing leads to a fixing of the layers with respect to each other and the draped 3D contour. For the preforming process, the fabric stacks are then transferred to a forming mould and transferred towards the contour of the future moulded part under pressure by closing the forming mould and cured by activation of the binder (heating and cooling), so that the semi-finished fibre product can be inserted close to its final contour into a mould of a press for performing the RTM process itself. The semi-finished fibre product will then be cut as required or punched out at predetermined positions in order to achieve an even more precise contour. After the insertion of the semi-finished fibre product into the mould, the mould halves are closed and the necessary resin is injected into the cavity of the mould, wherein the resin impregnates the fibre structure of the semi-finished fibre product, encloses the fibres and bonds them tightly into the resin matrix. The fibre-reinforced plastic component can then be removed from the mould after curing of the resin. In addition to the RTM process itself, the production of a semi-finished fibre product forms the foundation for the success in the production of a plastic component. It has been noticed that the state of the art describes a large number of possibilities for producing a preform, which are usually limited however to the manual or automated production of a fibre fabric stack which is as flat as possible and which is finally transferred from its 2D shape to a 3D shape in a press. This can be performed in a pre-fixed (e.g. sewed) state or still in a flexible state. The goal is to receive a preform after its shaping which has sufficient inherent rigidity in order to be inserted in a fully automated and operationally reliable manner into the mould of an RTM press, or which can be transported and removed from the stack for further use. There are various possibilities in the relevant state of the art for producing, shaping and fixing the preform.

In addition to the RTM process itself, the production of a semi-finished fibre product lays the foundation for the success in the production of a plastic component. The goal is to receive a preform from a non-rigid material after the shaping of the preform which is sufficiently rigid in order to be inserted in a fully automated and operationally reliable manner into the mould of an RTM press, or which can be transported and removed from the stack for further use. There are various possibilities in the relevant state of the art for producing, shaping and fixing the preform.

The following method steps are known for 3D forming of multilayer two-dimensional cutouts from fibre fabrics: fibre fabrics or laid scrims are wound off a roll and joined as required from several different fabrics or scrims, shapes and sizes into a fibre stack. It may be necessary to process or cut to size the outer and optionally the inner contour according to a cutting pattern of the preform or the plastic moulded part. The cutting pattern is produced from a development of the preform or the final component. The produced, substantially flat fibre stack is preferably draped by means of a draping device, or formed into a three-dimensional preform. In order to obtain a substantially rigid preform from a non-rigid fibre fabric it is mostly necessary that a binder is introduced between the individual layers and is subsequently cured.

It is state of the art that the fibre fabric or the fibre stack is heated by means of suitable heating apparatuses and is placed in a relatively cool or cold draping mould. The draping mould is then rapidly closed or draped accordingly in order to cure the binder. It has now been noticed that preliminary solidification of the binder in the laid scrim may occur especially in the case of complex geometries or large-area laid scrims when it is partly provided with good heat transmission for cooling. A closure of the mould now causes problems in forming because stiff or cured regions act as brakes and produce undesirable stress on the individual layers of the laid scrim. Shifting, vertical creases or similar problems occur in the careful configuration of the laid scrim, which endangers the consistency and quality of the future component. In order to avoid this, heating is usually performed clearly above the melting or activation temperature of the binder, which may lead to undesirable distortions in the laid scrim and also entails unnecessarily high energy consumption. Furthermore, a strongly heated laid scrim cannot be manipulated as well anymore.

It is the object of the invention to provide a method and a device in which despite rapid forming, especially of large-area and/or complex geometries, high-quality forming of the preform can be ensured.

This object of the method is achieved in such a way that the transport apparatus successively releases the laid scrim in the direction of the draping mould and the released regions of the laid scrim are fixed and or draped on the draping mould by means of a fixing stamp or a draping stamp.

The laid scrim is preferably heated in the transport apparatus. The temperature of an already tempered laid scrim in the transport apparatus should be set to and/or held at a predetermined minimum temperature. The minimum temperature can preferably correspond to the melting point of the binder within the laid scrim. The laid scrim is preferably kept under tension during the draping process by the draping stamp or the fixing stamp and the transport apparatus. A retaining apparatus on or in the transport apparatus can be used for establishing the tension. It can especially be provided that a combination of one or several belt trays and/or one or several trays are used as a transport apparatus.

The solution for the device is that means for the successive output of the laid scrim in the direction of the draping mould are arranged on or as the transport apparatus, and that a device is arranged in the draping apparatus which is suitable to fix or drape the laid scrim on the draping mould by means of displaceable fixing stamps and/or draping stamps according to the release of the laid scrim from the transport apparatus.

It can especially be provided that the transport apparatus comprises a tempering apparatus especially for maintaining the temperature of a preheated laid scrim and/or for heating the laid scrim above the melting point of the binder within the laid scrim.

It is now possible with these simple means to especially drape a laid scrim at all times with the optimal temperature, but in a successive fashion. The simple conveyance of a laid scrim to a draping device and the subsequently no longer reproducible draping is no longer necessary. A complex shape can now be draped in a purposeful fashion and laid scrim is only released or draped to such an extent as is permitted by the predetermined process.

The device is especially suited for performing the method, but can also be operated separately. It is now advantageously possible.

Further advantageous measures and embodiments of the subject matter of the invention are provided in the sub-claims and the following description with the drawings.

The possibilities for combination as represented in the description of the drawings can be utilised either independently and separately and in any combination. In particular, individual sentences shall also be construed as independent features.

The drawings show as follows:

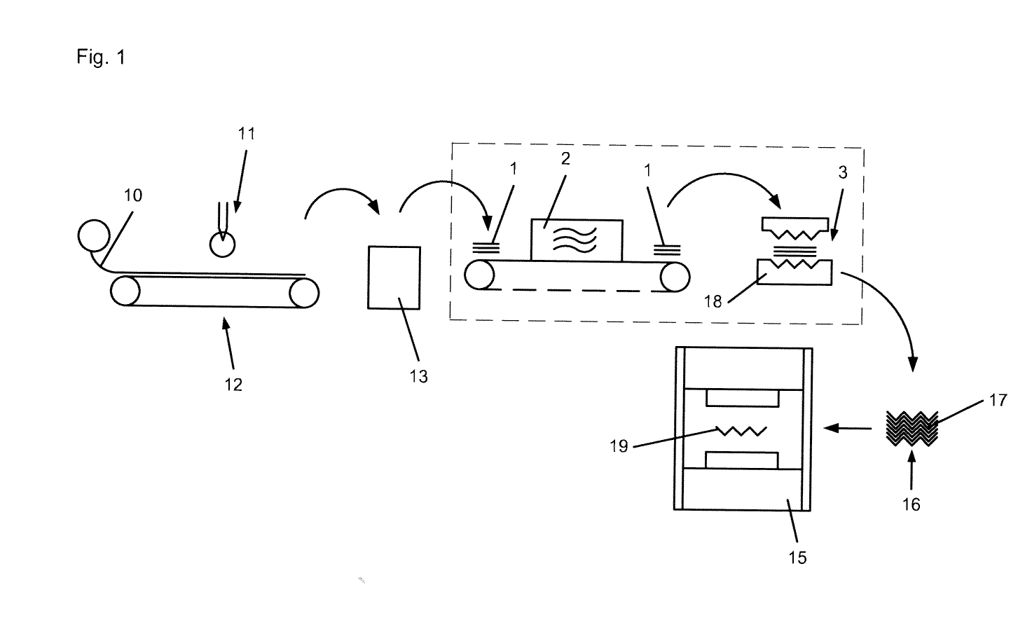

FIG. 1 shows an installation for producing fibre-reinforced moulded parts in a press by using preformed preforms as major industrial application in a schematic side view;

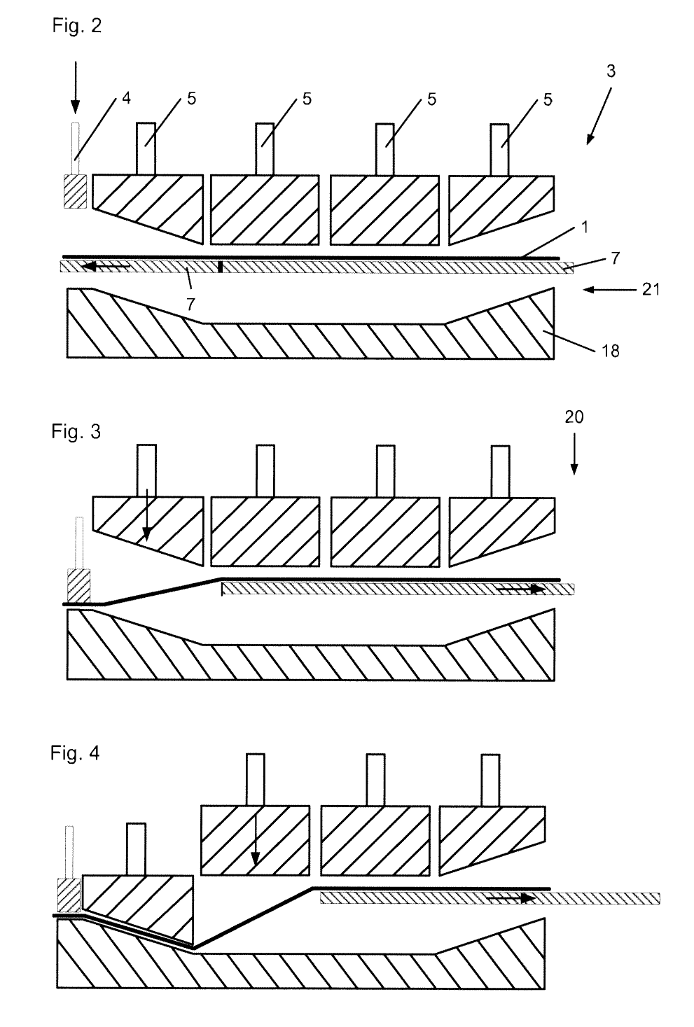

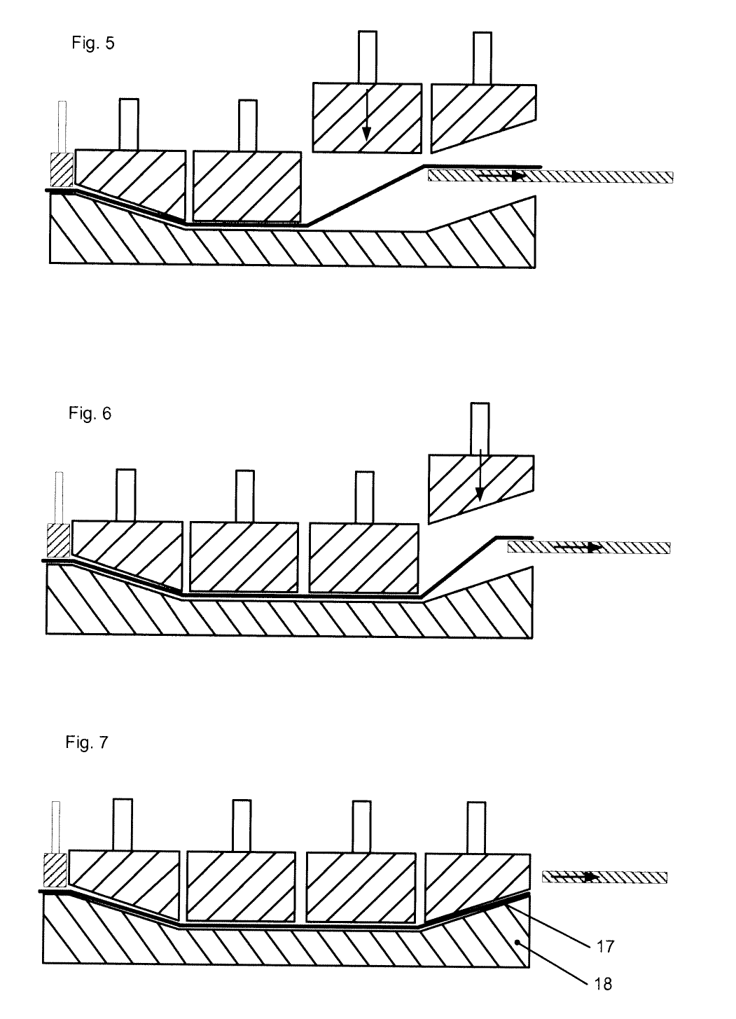

FIGS. 2 to 7 show a divided tray as a transport apparatus for the laid scrim in a draping device with an illustration of a possible step-by-step or continuous placing of the laid scrim in the draping mould, and

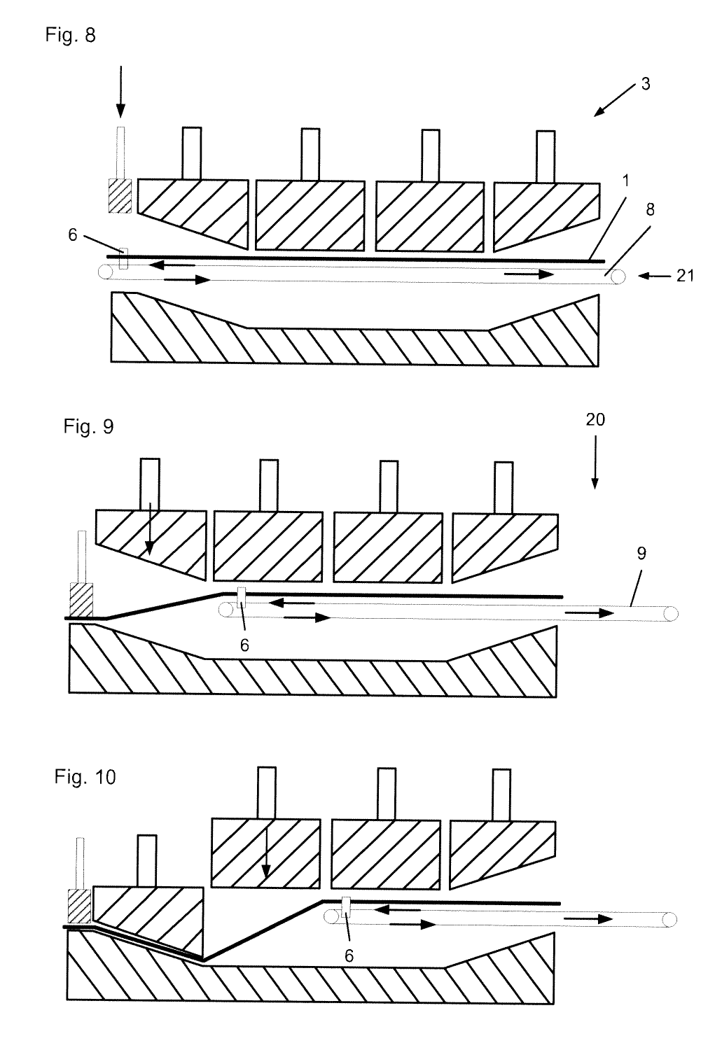

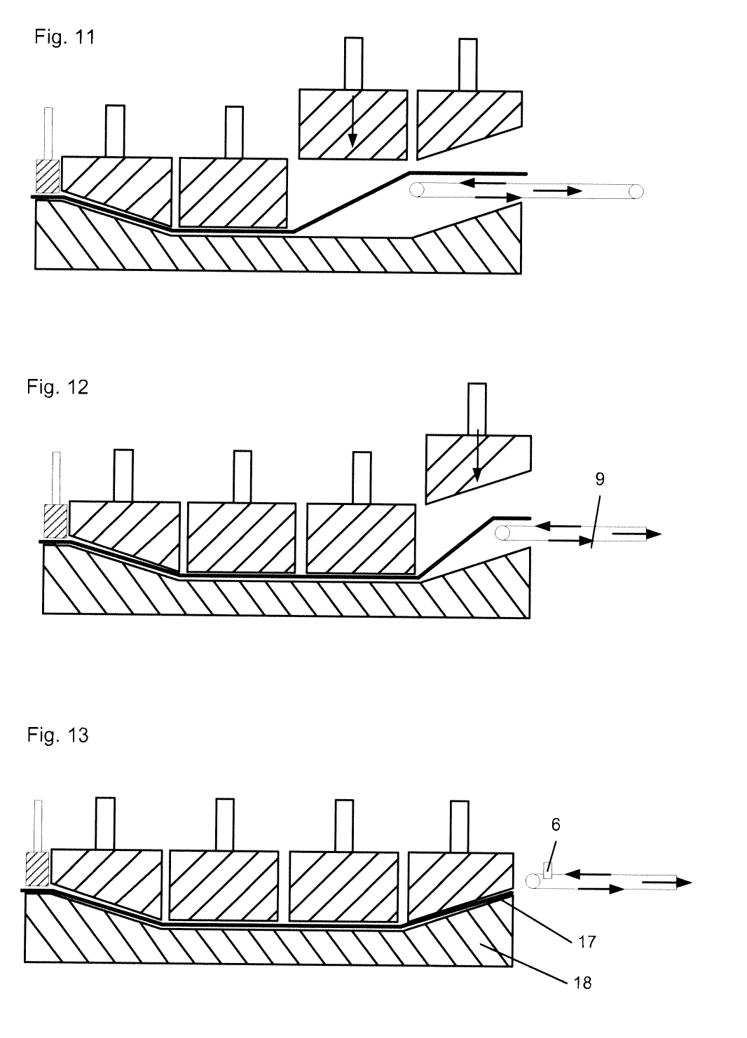

FIGS. 8 to 13 show the use of a belt tray as a transport apparatus according to the example of FIGS. 2 to 7.

FIG. 1 shows a schematic side view of an installation for producing fibre-reinforced moulded parts 19 in an RTM press 15 by using preformed preforms 17 in industrial production. For the purpose of producing a preform 17, one or several different fibre mats 10 are provided, preferably as roll merchandise, and cut on a cutting apparatus 12 with a cutting apparatus 11 into individual fibre mat cutouts (not shown). The contour of the fibre mat cutouts can substantially coincide with the contour of the preform 17 or the moulded part 19. It is also possible to produce predetermined partial geometries thereof. The fibre mat cutouts are then moved by means of a suitable transport apparatus (which is represented in FIG. 1 by the bent directional arrows) through a glue application apparatus 13 and are provided there with binder before they are joined into a laid scrim 1. Depending on the installation, the completed laid scrim 1 is subsequently tempered by a heating apparatus 2 and preferably increased to a temperature which corresponds at least to the melting temperature of binder. The laid scrim 1 is then moved to a draping device 3 and formed there by suitable means along the contour of the draping mould 18. The laid scrim 1 is subjected to cooling by the draping mould 18 of the draping device 3 and solidifies into a preform 16 which can usually be intermediately stacked without any problems on a stack 17 before it is pressed in an RTM press 15 into a reinforced moulded part 19.

A possible transport apparatus 21 is described in FIGS. 2 to 7, which is arranged in this case as a divided tray 7. A separate illustration of the optional tempering apparatus was omitted for reasons of clarity of the illustration. If a laid scrim 1 is preheated or is placed in a cold state on the transport apparatus 21 the transport apparatus can heat up the laid scrim 1 by means of the tempering apparatus, which is arranged in the tray 7 or also in an entrained fashion above the tray 7, or it will keep its existing temperature at least above the melting point of the binder.

If the transport apparatus 21 has moved into the draping device 3, the first part of the tray can be moved out of engagement with a part of the laid scrim 1 in the case of a divided tray 7. Different possibilities can be considered such as folding in, retracting or the like in the second part of the tray 7 itself, or even purposeful extension of the first part of the tray 7 from the draping device 3. It is possible that the necessary number of the parts of the tray 7 is a multiple and that at least one of these parts, and preferably all of them, is provided with the possibility for tempering or contains a tempering apparatus. Preferably, but not necessarily, a first fixing stamp 4 or a draping stamp 5 can respectively fix the released region of the laid scrim 1 on the draping mould 18 and also optionally form said scrim. Depending on the frictional resistance of the individual machine elements, the second part of the tray 7 can start to move out of the draping device 3, which occurs step-by-step or continuously as required. As is shown in FIGS. 3 to 7, the draping stamps 5 which are now moved in the draping direction 20 will form the laid scrim according to the contour of the draping mould 18 according to the “released” regions of the laid scrim 1 (which no longer lie on the transport apparatus). This occurs in the present example by the successive displacement of four draping stamps 5 in the draping direction 20. As a result, it is now possible to form an evenly preheated or tempered laid scrim 1 into a preform 17 in all regions of the draping mould 18.

In FIGS. 8 to 13, a belt tray 8 is arranged instead of a tray 7 as a transport apparatus 21. The belt tray can also be divided in accordance with the invention (not shown), or a tray 7 can be arranged in a supporting fashion which supports at least part of the laid scrim 1. The tempering apparatus is also not shown in this case, but it can effectively be provided in order to set or hold the laid scrim 1 resting on the belt tray 8 according to its temperature. The laid scrim 1 can be placed carefully in the draping mould 18 by the rolling belts 9 of the belt tray 8 and a simultaneous relative movement of the belt tray 8. The fixing of the first part of the laid scrim by means of a fixing stamp 4 can be provided as a precaution, especially in the case of complex geometries, but this is not necessary in the case of simple geometries of the draping mould 18.

It is also possible to provide other suitable means for draping instead of the draping stamp 5.

The tempering apparatus can be arranged as a convection radiator or also as a (resistance) heating apparatus for the transport apparatus 21. The described tray 7 is preferably heated to a respective temperature which is sufficient to respectively heat the laid scrim by means of the radiation heat emitted by the tray 7, or its potentially sufficient temperature is held above the melting point of the binder.

Depending on the application, the transport apparatus 21 can be subdivided several times by individual extension, or it can place the laid scrim according to requirements by a combination of the described possibilities. It can be considered in particular that the depositing of the laid scrim 1 needs to commence in the middle or in a boundary region or at two or more points simultaneously. It still remains a fact in a long-term draping process for example that laid scrims that have not yet been draped and placed on the draping mould 18 are heated to a sufficient temperature.

### LIST OF REFERENCE NUMERALS

1. Laid scrim
2. Heating apparatus
3. Draping device
4. Fixing stamp
5. Draping stamp
6. Retaining apparatus
7. Tray
8. Belt tray
9. Belt
10. Fibre mat
11. Cutting apparatus
12. Cutting table
13. Glue application apparatus
14. Preform
15. RTM press
16. Stack
17. Preform
18. Draping mould
19. Moulded parts
20. Draping direction
21. Transport apparatus

1. A method for producing a three-dimensional preform from a laid scrim in the course of production of fibre-reinforced moulded parts, comprising a draping apparatus and a transport apparatus for the laid scrim, wherein the draping apparatus comprises at least one draping mould for a laid scrim, and means displaceable to the draping mould for forming the laid scrim according to the contour of the draping mould, characterized in that the transport apparatus releases the laid scrim successively in the direction to the draping mould and the released regions of the laid scrim are fixed and/or draped by a fixing stamp and/or a draping stamp on the draping mould.

2. A method according to claim 1, characterized in that the laid scrim is heated in the transport apparatus.

3. A method according to claim 1, characterized in that the temperature of an already tempered laid scrim is set to and/or held at a predetermined minimum temperature in the transport apparatus.

4. A method according to claim 3, characterized in that the minimum temperature substantially corresponds to the melting point of a binder within the laid scrim.

5. A method according to claim 1, characterized in that the laid scrim is held under tension by the draping stamp or the fixing stamp and the transport apparatus.

6. A method according to claim 1, characterized in that for establishing the tension a retaining apparatus is used on or in the transport apparatus.

7. A method according to claim 1, characterized in that a combination of one or several belt trays and one or several trays is used as a transport apparatus.

8. A device for producing a three-dimensional preform from a laid scrim as a part of production of fibre-reinforced moulded parts, comprising a draping apparatus and a transport apparatus for the laid scrim, wherein the draping apparatus comprises at least one draping mould for a laid scrim, and means displaceable to the draping mould for forming the laid scrim according to the contour of the draping mould, characterized in that means for the successive output of the laid scrim in the direction of the draping mould are arranged on or as the transport apparatus, and that a device is arranged in the draping apparatus which is suitable to fix or drape the laid scrim on the draping mould according to the release of the laid scrim from the transport apparatus by movable fixing stamps and/or draping stamps.

9. A device according to claim 8, characterized in that a tempering apparatus is arranged on the transport apparatus at least for maintaining the temperature of a preheated laid scrim and/or for heating the laid scrim over the melting point of a binder within the laid scrim.

10. A device according claim 8, characterized in that at least a divided tray and a belt tray are arranged as a transport apparatus.

11. A device according to claim 8, characterized in that for introducing a tension into the laid scrim a retaining apparatus for the laid scrim is associated with the transport apparatus or arranged thereon.
